(19) United States
(12) Patent Application Publication
(10) Pub. No.: US 2026/0051315 A1
(43) Pub. Date: Feb. 19, 2026

(54) MULTI-MODAL SENSING AIDED ASSESSMENT AND FEEDBACK FOR ADAPTIVE LANGUAGE LEARNING

(71) Applicant: ARIZONA BOARD OF REGENTS ON BEHALF OF ARIZONA STATE UNIVERSITY, Scottsdale, AZ (US)

(72) Inventors: Ahmed Alkhateeb, Chandler, AZ (US); Gouranga Charan, Tempe, AZ (US)

(73) Assignee: ARIZONA BOARD OF REGENTS ON BEHALF OF ARIZONA STATE UNIVERSITY, Scottsdale, AZ (US)

(21) Appl. No.: 19/302,352

(22) Filed: Aug. 18, 2025

Related U.S. Application Data
(60) Provisional application No. 63/684,481, filed on Aug. 19, 2024.

(51) Int. Cl. G10L 15/02; G06V 40/18; G09B 19/06; G10L 15/18; G10L 25/18; G10L 25/78

(52) U.S. Cl. CPC G10L 15/02; G06V 40/18; G09B 19/06; G10L 15/1822; G10L 25/18; G10L 25/78; G10L 2015/025

(57) ABSTRACT

Language learning through the utilization of advanced multi-modal sensing technologies, including cameras (RGB and RGB-D), LiDARs, radars, IMUs, IR, and mmWave/THz sensors includes integration of the sensing technologies, and enables the detection of both physical cues—such as lip movements, facial expressions, head movements, and gaze direction—and auditory data captured by microphones, providing information about the language acquisition process. This multi-modal strategy enables voice activity detection, identification of active speech moments by learners, and pronunciation error analysis. The error analysis enables feedback that can improve speaking proficiency and learner engagement.

### CROSS-REFERENCE TO RELATED APPLICATIONS

This application claims the priority and benefit of U.S. Provisional Application No. 63/684,481, filed on Aug. 19, 2024, which is hereby incorporated by reference in its entirety.

### FIELD OF THE DISCLOSURE

The present disclosure is directed to enabling language learning.

### BACKGROUND

Mastering a new language encompasses the intricate coordination of reading, writing, speaking, and listening skills, each posing distinct challenges to learners. Traditional and existing digital language learning solutions, often constrained by their reliance on singular sensory modalities such as audio, fall short of fully addressing the complexity of these challenges. Learning a new language is a complex and multifaceted process, crucial in an increasingly globalized world where language proficiency can open doors to educational, professional, and cultural opportunities. Mastering a language involves not just learning new alphabets and expanding vocabulary, but also mastering sentence construction, pronunciation, and effectively engaging in listening, speaking, reading, and writing activities. Each aspect presents challenges for learners, especially non-native speakers, from articulating sounds not present in one's native language to understanding grammatical nuances and cultural idioms. This learning process is often hindered by the learner's native phonetic patterns and linguistic habits, leading to common mispronunciations, writing errors, and a reluctance to engage in conversation due to fear of making mistakes. Traditional methods of language learning, such as textbooks and classroom instruction, often fall short in addressing these individual nuances across all language skills, offering limited personalized feedback and interaction. Even modern language learning apps, while more interactive, struggle to provide the tailored feedback necessary for correcting pronunciation nuances and other language skills.

With the rapid advancement of technology, particularly in artificial intelligence (AI), machine learning, and multimodal sensing, there is a significant opportunity to transform language education. Machine learning, for example, has facilitated innovative applications in natural language processing, offering new ways to approach language learning. The integration of multi-modal sensing expands the potential further, as it incorporates visual, auditory, and possibly tactile feedback. Such technologies are not futuristic concepts but are already deployed in edge devices commonly used for learning, such as mobile phones, laptops, and augmented reality/virtual reality (AR/VR) headsets. For instance, the latest mobile phones are equipped with advanced sensors like depth cameras, red-green-blue-depth (RGB-D), light detection and ranging (LiDAR), and radio detection and ranging (radar), in addition to existing technologies such as cameras, microphones, and inertial measurement units (IMUs). Furthermore, current and future AR/VR devices are expected to boast even more sophisticated sensors, including those capable of eye tracking, gaze estimation, hand tracking, etc. This proliferation of multi-modal sensing capabilities makes language learning more accessible and inclusive, catering to diverse learning styles and needs. By leveraging these technologies, it is possible to provide a more holistic solution that not only encompasses comprehension, reading, writing, speaking, and listening skills but also addresses the limitations of current methods. This opens new possibilities for creating personalized and adaptive learning models that are more aligned with the technological capabilities of today's and tomorrow's devices.

A challenge in language learning, especially in pronunciation training, is not solely about hearing and reproducing sounds; it fundamentally involves understanding and replicating the physical aspects of speech production. This encompasses a range of complex movements within the vocal tract, a crucial but challenging area to measure and analyze. The intricacies of the vocal tract's operations, including subtle movements deep within, are difficult to capture with current technology. This is particularly true for non-native speakers, whose pronunciation struggles often stem from these nuanced internal movements. External aspects like lip and facial movements, while simpler than internal vocal tract movements, are more accessible and can be accurately detected and tracked with modern technology. Moreover, audio-only systems face additional challenges, such as interference from background noise or other speakers, which can further hinder the accuracy of pronunciation feedback.

Current advancements in language education technology have primarily centered around audio input, which, while beneficial, overlooks these vital visual cues. Audio-only systems, therefore rely solely on microphones, and fall short in analyzing external visual indicators which are necessary for a comprehensive assessment of pronunciation

Technological advancements have reshaped language learning, significantly enhancing vocabulary acquisition, grammar exercises, cultural competency, and engagement strategies. Studies have shown that innovations such as interactive content, gamification, and personalized feedback mechanisms are effective in increasing learner engagement and achievement. These strategies encounter limitations in fully meeting the diverse needs of learners and in maintaining their motivation over time. Additionally, the challenge of integrating these technological solutions into educational frameworks frequently emerges, with issues related to consistency across pedagogical approaches and ensuring accessibility in various learning environments. The demand for adaptable and flexible technologies in the global landscape of language learning underscores the necessity for solutions capable of addressing the requirements of learners across the world. Despite the advancements in feedback and correction mechanisms, most remain focused on isolated aspects of language learning, thereby lacking a holistic approach to language proficiency.

Focusing on pronunciation, an aspect of language learning, reveals the limitations of audio-based methods in capturing non-auditory speech aspects. Audio-based methods, particularly with the advent of advanced computational models, have been a focal point of research in recent years. While they have shown promise, these approaches often grapple with certain limitations, especially in capturing the non-auditory aspects of pronunciation. In the field of pronunciation error detection and correction, several audio-based approaches have made significant strides. Some systems utilize a text-conditioned transformer model to improve automatic pronunciation error detection (APED). These systems demonstrate how integrating target text as an additional condition can enhance the performance of APED systems. Some systems explore a weakly-supervised approach to detect pronunciation errors at the word level. This method offers a nuanced way of identifying errors without requiring extensive labeled data, which is often a challenge in pronunciation training research. Some systems delve into the potential of cross-lingual transfer learning. This approach leverages the acoustic modeling of one language to enhance pronunciation error detection in another, demonstrating the versatility and scalability of machine learning techniques in language learning applications. These recent systems represent a growing interest in utilizing advanced computational models to address the complexities of pronunciation error detection. While they showcase the potential of audio-based approaches, particularly in leveraging deep learning and transfer learning, they also highlight a challenge: the limited ability of audio-only methods to capture visual aspects of speech, such as lip movement and facial expressions. This limitation underscores the need for more holistic approaches that combine auditory and visual cues for a comprehensive understanding and correction of pronunciation errors.

Audio-visual methods have made strides in bridging the gap in pronunciation training. Some systems show how integrating audio and video data, by employing lip-reading techniques alongside audio analysis, leads to more accurate pronunciation detection. Similarly, some systems demonstrate the effectiveness of using synchronized audio-visual data to improve pronunciation learning, highlighting the benefits of visual feedback on learning outcomes. Some systems explore the use of 3D facial modeling to track mouth movements, merging these data with audio inputs for a comprehensive approach to pronunciation analysis. Despite these advancements, audio-visual approaches have raised privacy concerns due to the intrusive nature of continuous video monitoring for speech analysis. Some systems illustrate a potential adaptability for speech recognition. Some systems illustrate radar technology's application in motion detection across different domains that suggests innovative ways to analyze speech-related facial movements without the drawbacks of video monitoring. Although these modalities have yet to be widely adopted in pronunciation detection and correction, their proven ability to capture detailed motion and environmental data indicates a significant potential to enhance pronunciation training tools, marrying accuracy with privacy concerns.

What is needed is a system that solves the issues of accurate pronunciation that are sometimes absent from current language-learning structures. What is further needed is a way to incorporate a variety of audio and visual sensor modalities, for example, but not limited to, RGB and RGB-D cameras, LiDAR, IMUs, IR, radar, mmWave/THz imaging and audio data, to create a comprehensive way to learn languages. What is still further needed is a system in which the sensors allow for detailed detection of both physical cues such as, for example, but not limited to, lip movements, facial expressions, head movements, and gaze direction, and auditory data to provide the user with a robust understanding of the language.

### SUMMARY

Systems and methods in accordance with embodiments of the present disclosure include integrating multi-modal sensing technologies using sensors, such as, for example, but not limited to, microphones, cameras such as, but not limited to, RGB and RGB-D cameras, LiDAR, radar, IR, and mmWave/THz imaging sensors, with machine learning algorithms. This approach facilitates a comprehensive analysis of language learning dynamics, extending beyond mere speech analysis to include the dynamics of speech production, the subtleties of facial expressions during communication, and the spatial orientation relevant to reading and writing activities, as well as capturing additional environmental features. The primary objective of this system is to foster adaptive language learning by providing tailored, real-time feedback across the full spectrum of language skills, thereby developing an intelligent, responsive teaching system. This system is designed to identify individual learner deficiencies and environmental factors affecting learning, adapting its feedback and instructional methods accordingly. By doing so, this method not only overcomes the shortcomings of existing approaches but also significantly enhances the journey toward achieving language proficiency, offering a personalized learning experience that meets the needs and learning styles of each learner.

The multi-modal sensing technology integrates a range of sensory imaging modalities with audio data. Cameras and high-resolution imaging can capture detailed lip and facial movements, LiDAR can provide depth information for accurate spatial analysis, radar can detect subtle physical changes not visible to the naked eye, and mmWave/THz imaging can offer unprecedented insights into minute vocal tract movements. By harnessing these technologies, the system provides a solution for pronunciation training, capturing both auditory and visual aspects of speech. The system addresses the limitations of current audio-only systems and overcomes background noise and speaker interference through the application of multi-modal voice activity detection (VAD). The system can identify the speaker's voice, even in noisy environments, by combining visual cues with audio signals, thereby enhancing the effectiveness of pronunciation training.

Multi-modal sensing technologies offer the ability to provide comprehensive and nuanced feedback across language learning domains. By collecting and analyzing data from multiple sources including, for example, but not limited to, visual and auditory sources, multimodal sensing can tailor learning experiences to individual preferences and needs, dynamically adjust challenges, and offer real-time, personalized feedback. This approach not only enhances the efficacy of gamification and interactive content but also addresses the issues of consistency and accessibility in educational frameworks, making language learning more engaging, inclusive, and effective for a global audience.

Multi-modal sensing technologies emerge as a less intrusive yet comprehensive alternative to previous language learning solutions. These innovative technologies are capable of analyzing speech-related facial movements and other nuances without the privacy issues associated with video monitoring. Beyond merely addressing privacy concerns, multi-modal sensing is poised to significantly enhance the accuracy and effectiveness of pronunciation training by capturing detailed motion and environmental data. This method strikes a balance between accuracy and privacy, heralding a new era for its application across various aspects of language learning.

A system and method in accordance with embodiments of the present disclosure introduce advancements in language learning by harnessing the power of multi-modal sensing technologies and machine learning algorithms. Aspects of the system and method include comprehensive multi-modal sensing integration. By integrating a diverse array of sensors, including microphones, cameras, LiDARs, radars, IR sensors, and mmWave/THz imaging, the system captures auditory, visual, and other types of data. This approach enables deep analysis that extends beyond the capabilities of current language learning platforms (using a single modality as input), offering insights into the learner's interaction and environment. Another aspect of the system is the development of multi-modal machine learning models. The machine learning models can process and understand data from different modalities. They extract and fuse auditory and visual inputs. The models analyze the nuanced aspects of language learning, such as pronunciation and grammar, tailoring feedback and recommendations to individual learner profiles. Accurate identification of error root causes and tailored feedback can be enabled by multi-modal data. Multi-modal data enables the system to pinpoint the cause of language errors, particularly in pronunciation, enabling highly personalized feedback. For example, when two students both mispronounce the word “hello” in English, multi-modal data can provide personalized feedback. In the case of the first student, audio data shows the word sounds muffled. Visual data reveals the first student is not opening the mouth wide enough. Tailored feedback to the first student can include that the system instructs the student to open the mouth wider when speaking, providing visual demonstrations and exercises to practice proper mouth opening. In the case of the second student, audio data also shows the word sounds muffled. Visual data shows the student is opening the mouth adequately. The system considers possible reasons for the mispronunciation, such as the second student's not speaking loudly enough, the microphone's being in incorrectly positioned, etc. The system can provide tailored feedback such as, for example, guiding the student to speak more loudly and reorient the microphone if needed. In this example, while both students'pronunciation sounds similar (muffled), the root causes are different. The multi-modal approach enables the system to identify these differences and provide tailored, specific feedback to each student.

The system uses multi-modal data to assess the learner's emotional state and adapts the learning experience accordingly. For example, if the system detects frustration (through facial expression analysis, voice tone, and possibly increased error rates), it might slow down the pace, offer more encouragement, or switch to easier content temporarily. If the system detects high engagement and positive emotions, it might introduce more challenging material or increase the pace to maintain motivation. The system may adjust the type of content based on emotional cues, perhaps introducing more interactive or game-like elements when it detects boredom or fatigue. This emotion-aware approach ensures that the learning experience is not just personalized in terms of content but also in how the content is delivered, maintaining an optimal emotional state for learning.

The system and method enrich the learning experience by providing an understanding of the learner's environment and behaviors. The advantages include detailed environmental and interactional insights. Multi-modal sensing enables the system and method to capture the impact of the various factors in the environment surrounding the learner, such as the interactions between the learner and the surrounding people. The system can (i) conduct assessments of learner performance, (ii) provide feedback that is tuned to the specific context and needs of the user, (iii) capture the learner's language generation features, and (iv) identify the reason(s) for mistakes. Pinpointing mistakes facilitates targeted interventions, and enhances the learner's ability to grasp and correct specific speech generation or language use issues. Another feature of a system and method in accordance with embodiments of the present disclosure is VAD. Including multi-modal sensing improves VAD by providing visual cues and gesture recognition. Cameras can detect lip movements and facial expressions, helping to identify when the learner is speaking, even in noisy environments. Sensors such as, for example, cameras, LiDAR, radar, and IR sensors, can detect hand gestures or body language associated with speaking, providing additional confirmation of voice activity. These features help distinguish the learner's speech from background noise and interference from other speakers. VAD is used for speech recognition and assessment, and ensures that feedback is based on the learner's actual inputs. Another aspect is immersive learner perception analysis. Multi-modal sensing provides a perception of the learner's experience, capturing emotional states and levels of attention, enabling the system to provide an adaptive and personalized learning experience, adjusting in real time to the learner's engagement and emotional cues. Multi-modal sensing enables adaptive and personalized learning through facial expression analysis, eye-tacking, and posture movement and analysis. Cameras can detect expressions indicating confusion, frustration, or engagement, allowing the system to adjust difficulty or provide additional support. Eye-tracking can measure attention and focus, helping the system identify when to introduce new content or review difficult concepts. Body language can indicate engagement levels or fatigue, prompting the system to adjust lesson pacing or suggest breaks. Interaction patterns can track how the learner interacts with the system (e.g., response times, error rates), and can indicate engagement and understanding. Voice tone analysis through audio processing can detect emotional states from the learner's voice, providing another dimension of emotional feedback.

Multi-modal sensing for pronunciation error detection uses, for example, but not limited to, cameras, LiDAR, radar, IMUs, and traditional audio feedback mechanisms for in-depth capture and analysis of auditory and visual effects of speech. Stages of sensing system include, but are not limited to including, data acquisition, data synchronization, feature extraction, prediction, and error detection and feedback. Data acquisition includes collecting data from microphones and other sensors to create a broad spectrum of auditory and visual data for evaluating speech production, ensuring that speech nuance is recorded and analyzed. Data synchronization synchronizes the data modalities together so that pronunciations are accurate. Feature extraction analyzes nuances in speech and expressions, and divides the audio into distinct segments with multiple labels. For example, VAD may be used to identify speech presence and lip movement to better understand layered nuances in pronunciations. Prediction uses the extracted features from the previous stage, and applies machine learning models to these data points in order to predict phoneme accuracy, or analyzes the raw synchronized data without extracted features for a more comprehensive view of the language. Error detection and feedback highlights pronunciation errors and provides corrective feedback for the user. The feedback is tailored to address the specific needs of the learner. For example, the learner may be provided visual diagrams, and auditory comparison between the learner's pronunciation and the standard pronunciation.

Pronunciation error detection technology includes, but is not limited to including, data capture, sensor data encoding, and prediction. Data capture employs, for example, but not limited to, audio sensors to capture tone, pitch, and rhythm, and concurrently uses cameras to record visual aspects of speech such as, for example, but not limited to, lip movement, facial expressions, and tongue positioning. Data can be captured from other modalities as well, not limited to audio and visual data. Sensor data encoding includes formatting raw data into a file suitable for digital interpretation and analysis. The system processes the encoded data to predict phonemes. The machine learning model is, for example, a blend of Convolutional Neural Networks (CNNs) and Recurrent Neural Networks (RNNs) with Connectionist Temporal Classification (CTC).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for assisted language learning. The method includes acquiring sensor data from a speaker from a plurality of modalities, extracting features from the acquired sensor data, aligning the sensor data from the plurality of modalities, analyzing the aligned sensor data as a temporal sequence, identifying deviations from expected pronunciations by comparing a model of dynamics of speech over time with the analyzed aligned sensor data, and providing feedback to the speaker based on the deviations. Other embodiments of this aspect include corresponding computer systems, apparatus, and computer programs recorded on one or more computer storage devices, each configured to perform the actions of the methods.

Implementations may include one or more of the following features. The method may include predicting phonemes by providing the analyzed aligned sensor data to a trained machine learning model, determining pronunciation errors based on a comparison of the predicted phonemes with ground truth phonemes, and providing the feedback to the speaker based on the pronunciation errors. The method may include classifying the deviations based on a type of error. The feedback may include highlighting areas where pronunciation differs from language norms. The sensor data are acquired substantially contemporaneously. The method may include transforming raw waveforms of the sensor data into a spectral representation that highlights or isolates features. The features may include one or more of facial movements or articulatory gestures related to speech sounds. The method may include training a machine learning model to predict phonemes based at least on the features. The trained machine learning model may include a sequence model architecture. The method may include identifying speech presence using voice activity detection. The method may include determining a direction and an angle of the speaker during speech based on head orientation. The method may include determining where the speaker is looking based on gaze estimation. The method may include determining environmental influence on a speaker's articulation and attention based on environmental conditions. The method may include performing a segment-by-segment dissection of a speaker's speech to determine aspects of components involved in pronunciation. The sensor data may include image data and audio data from a speaker. The plurality of modalities may include one or more of an audio sensor, a visual sensor, a lidar sensor, a radar, a mmwave/THz sensor, or an IR sensor. Analyzing the aligned sensor data may include combining features using cross-model attention. The method may include dividing the senso data into segments, and annotating the segments with one or more labels. Implementations of the described techniques may include hardware, a method or process, or computer software on a computer-accessible medium.

One general aspect includes a computer system for assisted language learning. The computer system includes a hardware processor, and a non-volatile storage medium storing instructions that when executed by the hardware processor perform operations may include acquiring sensor data from a speaker from a plurality of modalities, extracting features from the acquired sensor data, aligning the sensor data from the plurality of modalities, analyzing the aligned sensor data as a temporal sequence, identifying deviations from expected pronunciations by comparing a model of dynamics of speech over time with the analyzed aligned sensor data, and providing feedback to the speaker based on the deviations. Other embodiments of this aspect include corresponding computer systems, apparatus, and computer programs recorded on one or more computer storage devices, each configured to perform the actions of the methods.

One general aspect includes a computer program product for assisted language learning. The computer program product includes a computer readable storage medium having program instructions embodied therewith, the program instructions executable by a computing device to cause the computing device to perform operations including acquiring sensor data from a speaker from a plurality of modalities, extracting features from the acquired sensor data, aligning the sensor data from the plurality of modalities, analyzing the aligned sensor data as a temporal sequence, identifying deviations from expected pronunciations by comparing a model of dynamics of speech over time with the analyzed aligned sensor data, and providing feedback to the speaker based on the deviations. Other embodiments of this aspect include corresponding computer systems, apparatus, and computer programs recorded on one or more computer storage devices, each configured to perform the actions of the methods.

It is to be understood that both the foregoing general description and the following detailed description are exemplary and explanatory only and are not restrictive of the present teachings, as claimed.

### BRIEF DESCRIPTION OF THE DRAWINGS

The accompanying drawings, which are incorporated in and constitute a part of this specification, illustrate aspects of the present teachings and together with the description, serve to explain the principles of the present teachings.

FIG. 1 is a pictorial representation of a pronunciation training system;

FIGS. 2A-2D are pictorial representations of the core components of a system in accordance with embodiments of the present disclosure, illustrating pronunciation assistance and background tasks; and

FIG. 3 is a flowchart of a method in accordance with embodiments of the present disclosure.

It should be noted that some details of the figures have been simplified and are drawn to facilitate understanding rather than to maintain strict structural accuracy, detail, and scale.

### DESCRIPTION

Reference will now be made in detail to the present teachings, examples of which are illustrated in the accompanying drawings. In the drawings, like reference numerals have been used throughout to designate identical elements. In the following description, reference is made to the accompanying drawings that form a part thereof, and in which is shown by way of illustration specific examples of practicing the present teachings. The following description is, therefore, merely exemplary. The developed technology is crafted with a profound comprehension of language learning as an inclusive process, spanning speaking, listening, reading, and writing. It surpasses basic auditory processing by incorporating a variety of sensory inputs to enhance facets of language acquisition.

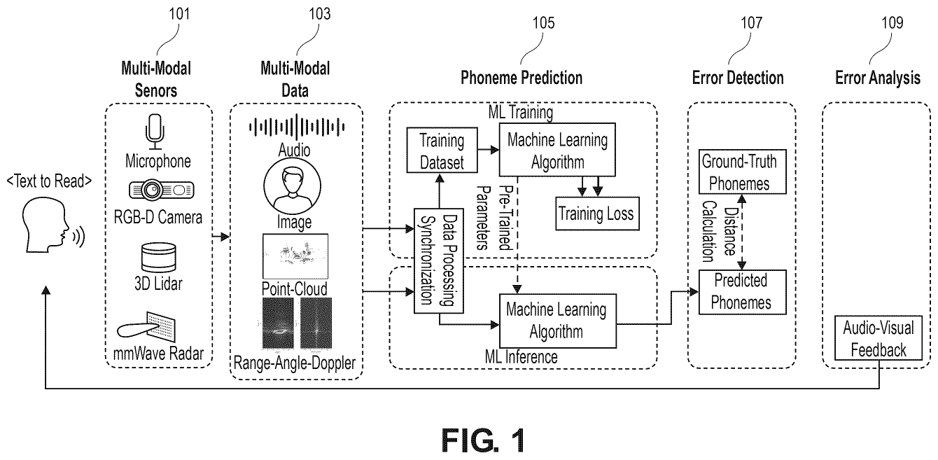

Referring now to FIG. 1, language learning through the utilization of advanced multi-modal sensing technologies, including cameras (RGB and RGB-D), LiDARs, radars, IMUs, IR, and mmWave/THz sensors is described. The pronunciation training system captures audio-visual data through an array of sensors, processing these data using machine learning algorithms for phoneme prediction, and conducting error analysis to furnish immediate, personalized feedback, facilitating tailored language learning experiences.

Integration of the sensing technologies enables the detection of both physical cues such as lip movements, facial expressions, head movements, and gaze direction, and auditory data captured by, for example, microphones, providing information about the language acquisition process. This multi-modal strategy enables VAD, identification of active speech moments by learners, and pronunciation error analysis. The error analysis enables feedback that can improve speaking proficiency and learner engagement. The system and method in accordance with embodiments of the present disclosure can track gaze and head movements, and illuminate reading patterns and comprehension challenges. These data can inform the design of targeted interventions for reading and writing such as correcting pronunciation errors, conducting fluency assessments, and recommending vocabulary enrichment exercises. The system and method can, for example, automatically detect voice activity, filter ambient noise, and adjust lighting that can sharpen the learner's ability to understand linguistic nuances.

A multi-modal sensing framework in accordance with embodiments of the present disclosure enhances language learning through pronunciation error detection and correction. In some configurations, a variety of sensors, including cameras, LiDAR, radar, and IMUs, is integrated with audio feedback mechanisms. Capture and analysis of both auditory and visual aspects of speech facilitates identifying and correcting pronunciation mistakes. Immediate, personalized feedback based on the dual analysis can improve pronunciation accuracy and learner confidence.

Speech involves a blend of vocal tract movements and respiratory control, engaging the tongue, lips, jaw, and larynx, for example. For example, the way the lips come together for sounds like ‘b’ or ‘p’, or how the tongue positions itself for ‘l’ or ‘r’, impacts the accuracy of pronunciation. Lip and facial movements produce distinct sounds. This is particularly evident in sounds that are visually distinguishable, known as “visemes”. For language learners, especially non-native speakers, observing these movements enables mimicking accurate pronunciation. This visual aspect of speech is often overlooked in traditional audio-only pronunciation training methods. Combining visual feedback with auditory feedback aids in learning new words and sounds. The ability to observe and replicate lip and facial movements can lead to improvements in pronunciation accuracy. This understanding underlines the use of an approach that transcends audio-only methods. Pronunciation training involves identifying where the student is making mistakes and providing feedback to the student.

Various sensors, for example, but not limited to, cameras, LiDAR, and radar, can capture the student's speech production mechanism. For example, a camera can record the movement of lips and tongue, and a LiDAR can provide spatial information associated with facial movements. The LiDAR data can be used to detect misarticulations and deviations from standard speech patterns. In a system in accordance with embodiments of the present disclosure, sensors that record facial movement and spatial information sensory inputs are integrated with audio data, and the integrated data are analyzed to identify pronunciation errors and provide feedback to the student, where the feedback addresses both auditory and movement and spatial inaccuracies. For example, when the student pronounces of the word “bat”, a system and method in accordance with embodiments of the present disclosure capture acoustic properties from audio sensors, and capture information about how the lips close and open, an action that enables the articulation of “b”. The acoustic properties and the information about how the lips close and open are integrated and assessed to determine if both auditory and facial movement aspects align with standard pronunciation. If a discrepancy is detected, the system provides targeted feedback, addressing the specific aspect of pronunciation that needs correction.

A system and method in accordance with embodiments of the present disclosure include data acquisition, data synchronization, feature extraction, prediction, and error detection and feedback. With respect to data acquisition from multi-modal sensors 101, speech data from, for example, but not limited to, microphones and auxiliary inputs from an array of sensors are collected. The array of sensors can include, but is not limited to including, cameras, LiDAR, radar, and IR sensors. These sensors capture auditory and facial movement data (multi-modal data 103), detailing the multifaceted physical dynamics of speech production, providing a dataset for error analysis 109. With respect to data synchronization, the system and method can, for example, synchronize the data modalities through either system design or subsequent post-processing methods. Synchronization ensures alignment of multimodal data streams, establishing a foundational dataset for analysis. Synchronization maintains temporal integrity between the different data modalities to enable pronunciation error detection and training of a machine learning model. With respect to feature extraction, the audio data are divided into segments for detailed analysis. Data collected by the sensors are used to annotate the segments with one or more labels. For example, VAD may be used to identify speech presence, lip movement may be used to capture the nuances of lip positioning for different sounds, head orientation may be used to determine the direction and angle of the head during speech, gaze estimation may be used to determine where the speaker is looking, and environmental conditions may be used to determine environmental influence, such as other individuals, on the speaker's articulation and attention. The system and method in accordance with embodiments of the present disclosure perform a segment-by-segment dissection of the speaker's speech to determine aspects of auditory and visual components involved in pronunciation.

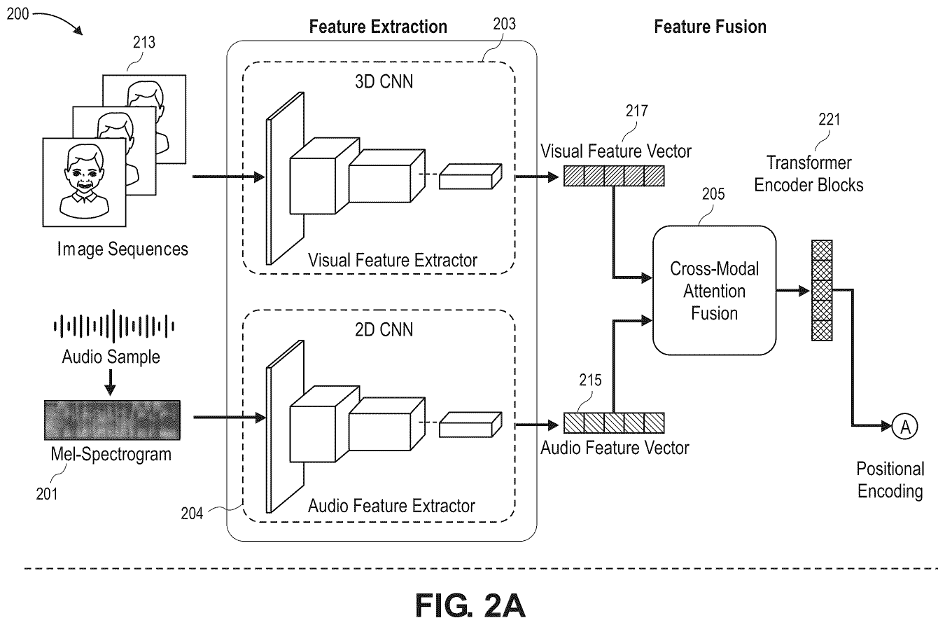

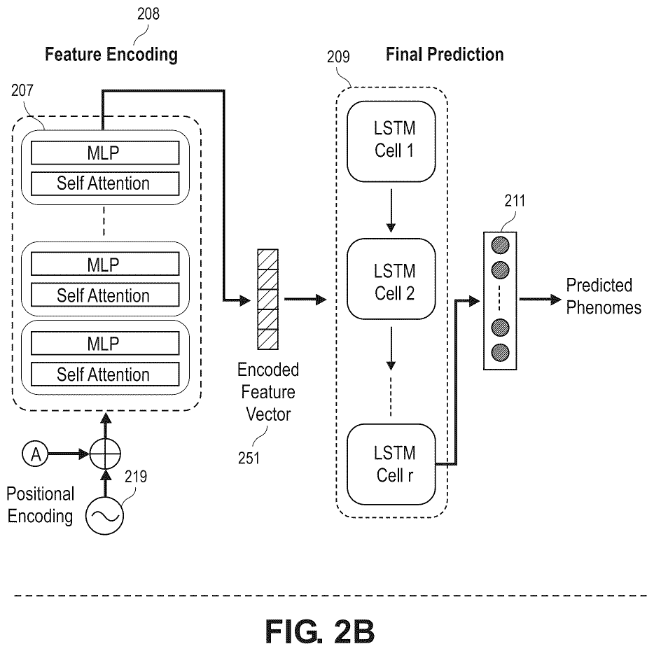

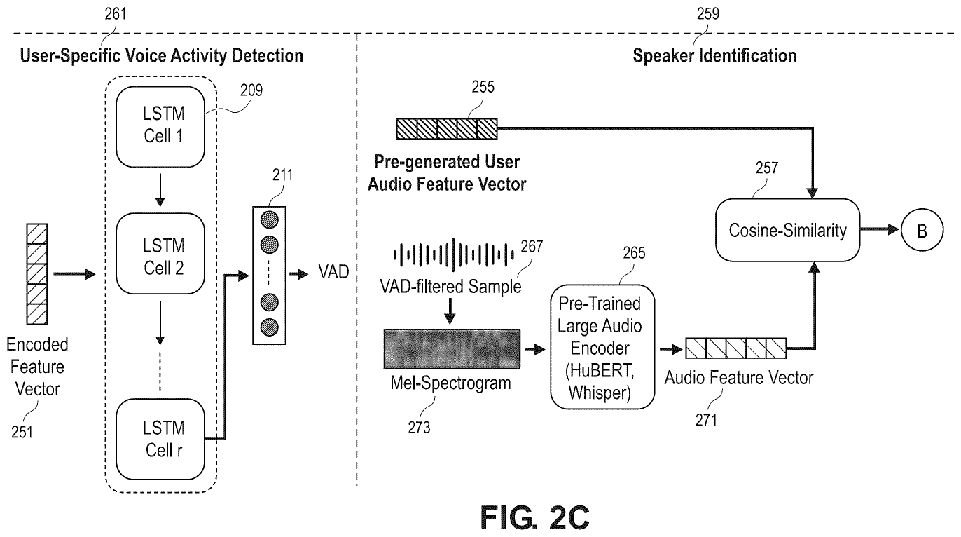

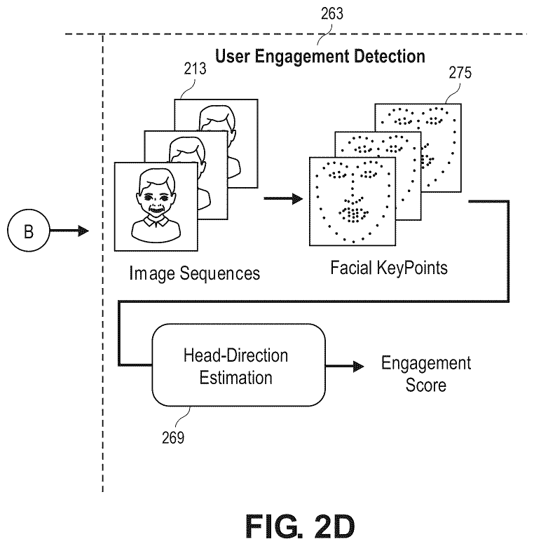

With respect to prediction 105, machine learning models are applied to the extracted features to predict phoneme accuracy. A first machine learning model uses the extracted features, assesses phoneme production, and gauges emotional states, attention levels, and other learner traits, offering a detailed perspective on the learner's language learning journey. A second machine learning model can analyze the raw, synchronized data without extracting the features, providing a comprehensive assessment of language learning aspects, including but not limited to, pronunciation accuracy, learner engagement, and overall language competency. The two machine learning models together provide an analysis for language learning feedback. An example of pronunciation error detection using audio and visual data is shown in FIG. 2A. The two models shown in FIG. 2A are for modality-specific feature extraction. Specifically, the 3D CNN model 203 is used to extract features from the visual data (sequence of images 213), and the 2D CNN model 204 is used to extract features from the audio data (Mel-spectrograms 201).

Continuing to refer to FIG. 1, with respect to error detection and feedback 107, the system and method in accordance with embodiments of the present disclosure address needs and preferences of the student. When a pronunciation error is detected, the system and method in accordance with embodiments of the present disclosure highlight the pronunciation error and provide corrective feedback associated with the student's learning style. This is determined by comparing the predicted phonemes generated by the system with the ground-truth phonemes of the text being read. The system accesses correct phonemes for the given text, which allows the system to identify errors by directly comparing the student's pronunciation (as captured by the system's predictions) against the known correct pronunciation. When mismatches are detected between the predicted and ground-truth phonemes, these are flagged as pronunciation errors. For example, for visual learners, the feedback might include an animated articulation diagram showing the correct tongue and lip positions. For auditory learners, a comparison between their pronunciation and the standard pronunciation might be provided, alongside exercises designed to practice the specific sound.

A system and method in accordance with embodiments of the present disclosure can be used for language education for non-native speakers who face challenges in mastering a new language and for young learners embarking on their initial language acquisition journey. A system and method in accordance with embodiments of the present disclosure can be used for personalized speech therapy. Individuals with speech impairments or articulation disorders can benefit from the detailed feedback on both sound and visual aspects of speech that the system provides. This feedback allows for the development of targeted therapy plans and offers real-time, actionable guidance during therapy sessions. A system and method in accordance with embodiments of the present disclosure can be used by educational software and tools in classroom settings or through digital learning platforms. Educators can offer a learning experience that can cater to the varied needs of students. This includes providing young language learners with an intuitive and interactive way to practice and improve their pronunciation, thereby enhancing their overall language learning experience.

Referring now to FIGS. 2A-2D, to detect errors in multi-modal pronunciation, a machine learning approach in accordance with embodiments of the present disclosure integrates data from various sensing modalities. To integrate the data from the various sensing modalities, features are extracted, sensor fusion is performed, and decision-making is performed. Specialized feature extraction methods accommodate audio, visual, LiDAR, radar, mmWave/THz, and other sensors, and capture relevant characteristics of speech production. Other examples using other modalities are contemplated by the present disclosure. The pronunciation model processes image sequences 213 (FIG. 2A) and audio samples 201 (FIG. 2A) through CNNs 203/204 (FIG. 2A) for feature extraction to feature vectors 215/217 (FIG. 2A), fuses them using cross-modal attention 205 (FIG. 2A), encodes them with transformer encoder blocks 221 (FIG. 2A), and analyzes them over time using long short-term memory (LSTM) cells to predict phonemes for targeted feedback. The system incorporates user-specific VAD using LSTM cells 209 (FIG. 2B) on audio feature vectors 215 (FIG. 2A) extracted from the transformer encoder block 221 (FIG. 2A), speaker identification employing a pre-trained audio encoder and cosine similarity comparison with stored embeddings, and user engagement detection that estimates head direction from facial keypoints extracted from image sequences 213 (FIG. 2A). Sensor data fusion, combining information across modalities, includes, but is not limited to including, cross-modal attention mechanisms. The fused representations are fed into decision-making models, such as, for example, but not limited to, sequence modeling architectures such as transformers or LSTM RNNs, to detect and classify pronunciation errors.

Continuing to refer to FIGS. 2A-2D, system 200 (FIG. 2A) allows for the flexible incorporation of various sensing modalities, each contributing insights into the speech production process. System 200 (FIG. 2A) enables a method of pronunciation error detection using audio-visual data that integrates the audio and visual data. By combining auditory and visual cues, the method provides an analysis of speech production and pronunciation. The method includes, but is not limited to including, data acquisition, pre-processing, feature extraction, temporal alignment and fusion, sequence modeling and decoding, and error detection. Data acquisition includes, but is not limited to including, the capture of sensor data such as, for example, but not limited to, audio and visual data, for example, substantially contemporaneously. Audio sensors record spoken words, capturing auditory elements such as tone, pitch, and rhythm. Video cameras record the visual aspects of speech production, including, but not limited to including, lip movements, facial expressions, and visible articulatory gestures. Sensors such as LiDAR and radar can be used to capture aspects of speech production such as 3D mapping of articulatory movements provided by LiDAR, and tongue and palate positions. Radar can provide movements of the vocal tract or larynx. The raw sensor data are pre-processed to prepare them for analysis. For example, audio pre-processing involves transforming the raw waveforms into a spectral representation that highlights relevant acoustic features, and visual pre-processing focuses on identifying and isolating the face and lip region of the speaker from the video frames. The system extracts meaningful features from the pre-processed sensor data. For example, audio feature extraction includes identifying acoustic characteristics that are indicative of proper or improper pronunciation. Visual feature extraction includes capturing the dynamics of lip movements and other visible articulatory gestures that correspond to specific speech sounds. The features are temporally aligned or synchronized and combined or fused. The combined features are analyzed as a temporal sequence. A model of the dynamics of speech over time, considering the context and interdependencies between different parts of the utterance, is used as a baseline against which measured sensor data are compared. Sequential analysis enables understanding the flow of speech and identifying potential pronunciation errors within the context of continuous speech. The system compares the analyzed speech sequence against standard pronunciation models, identifying deviations from expected pronunciations, classifying them into various types of errors, such as phoneme substitutions, insertions, or deletions. Error detection is used to provide feedback to language learners, highlighting areas where their pronunciation differs from the target language norms.

Continuing to refer to FIGS. 2A-2D, models used throughout the system 200 (FIG. 2A) and associated method in accordance with embodiments of the present disclosure integrate convolutional neural networks (CNNs) 203/204 (FIG. 2A), attention mechanisms, and transformer models to process and analyze the fused sensor data for effective pronunciation error detection. For example, audio data raw waveforms can be pre-processed by converting them into mel-spectrograms 201/273 (FIG. 2A/2C). This process involves applying a short-time Fourier transform (STFT) to the audio signal. The resulting spectrogram is then passed through a mel-scale filterbank 267. The Mel spectrogram 201/273 (FIG. 2A/2C) represents the power spectrum of the audio signal on a melody scale. For visual data, a face detection model is used, for example, to identify and extract the lip region from each video frame. Models that use the Multitask Cascaded Convolutional Networks (MTCNN) algorithm or the RetinaFace model can be used. These models locate facial landmarks, which are used for estimating head pose and gaze direction. In some configurations, extracted lip regions are resized to a standard dimension using bilinear interpolation to maintain image quality.

Deep learning architectures tailored for each modality are used to extract features. For example, a modified ResNet architecture is employed to extract audio features. The ResNet architecture is modified by changing the initial convolutional layer to accept mel-spectrogram input 201. The final fully connected layer is adjusted to output a feature vector of a specified dimension. For visual feature extraction, for example, a 3D Convolutional Neural Network (3D CNN) 203 is used. The 3D CNN 203 starts with a 3D convolutional layer, followed by alternating 3D convolutional layers and 3D max pooling layers. The network ends with a global average pooling layer and a fully connected layer to produce the final feature vector 217. A cross-modal attention mechanism 205, for example, is used to align and fuse the sensor data features. For example, the audio and visual features are projected into a common embedding space. Attention weights are computed between the audio and visual frames, creating an attention matrix. The attention matrix is used to create aligned, fused features by weighting the visual features for each audio frame. The fused features are processed by, for example, a Transformer encoder 208 that encodes features followed by an LSTM-based decoder architecture 209. The Transformer encoder 208 includes multiple layers 207, each with a multi-head self-attention and a position-wise feed-forward network. The Transformer encoder 208 uses sinusoidal positional encodings 219 to incorporate sequence order information for the transformer encoder input 221. The decoder includes a series of LSTM cells 209 that process the encoder's output sequentially. Each LSTM cell 209 takes the previous cell's output and a context vector 251 derived from the encoder's output as inputs. This allows the decoder to maintain temporal dependencies while using the representations produced by the Transformer encoder 208.

The model is trained using, for example, but not limited to, Connectionist Temporal Classification (CTC) loss for phoneme prediction. The optimization process uses the Adam optimizer with a learning rate schedule that includes warm-up and decay phases.

The system includes error detection and provides feedback. User-specific VAD 261 identifies when the user is speaking, for example, to isolate relevant speech segments. Speaker identification 259 ensures that the intended user's speech is processed so that the system can be used in multi-speaker environments. Engagement and emotion detection systems 263 assess the user's psychological state to understand factors that affect pronunciation. These components run in the background, analyzing various aspects of the user's speech and behavior. These analyses provide a context for error detection. When a pronunciation error is identified, the system conducts a root cause analysis by examining the outputs of these background tasks at various times.

User-specific VAD 261 detects when the user is speaking by using audio and visual cues. Inputs to the system include, but are not limited to including, an audio stream and synchronized video frames, and outputs including, but are not limited to including, time-stamped segments of user speech. The ML component includes an audio path where a 2D CNN 265 processes mel-spectrograms 273 derived from the audio stream, in parallel with a visual path where a 3D CNN analyzes sequences of video frames, capturing lip movements and facial expressions. These features are fused using a cross-modal attention mechanism. The fused features are processed by a recurrent neural network to output VAD decisions.

Speaker identification 259 enables the system to process the intended user's speech in multi-speaker environments. In some configurations, audio segments are identified by the VAD as input, and the speaker identity confirmation is output. Pre-collected and prepared speaker embeddings, obtained during an initial setup phase, may be used. For each audio segment, the system may extract speaker embeddings 271 using a pre-trained neural network such as, for example, but not limited to, HuBERT. These extracted speaker embeddings 271 are compared to the pre-saved speaker embeddings 255 using, for example, but not limited to, cosine similarity 257. If the similarity score exceeds a predefined threshold, the system confirms the identity of the speaker. The use of pre-saved speaker embeddings 255 enables the system to maintain performance across sessions without the need for repeated enrollment, enhancing the user experience in long-term language learning scenarios.

Engagement and emotion detection 263 assesses the user's engagement level and emotional state to tailor feedback. For engagement, images 213 may be used to estimate head pose and gaze direction. A CNN model such as MTCNN or RetinaFace extracts facial landmarks and key points 275, which are then used to compute the head orientation and gaze vector 269 (FIG. 2D) relative to the screen. This provides a direct measure of visual engagement. For emotion detection, the system may use multi-modal architecture, for example, but not limited to, the multi-model architecture used in the phoneme prediction model. This approach uses an existing audio-visual processing pipeline, which includes 2D CNNs for processing mel-spectrograms of speech, 3D CNNs for analyzing facial expressions in video sequences, and cross-modal attention for feature fusion. Since this architecture is similar to the components of the phoneme prediction model, a fully-connected layer is added to the output 211 of the LSTM to predict basic emotions, for example, but not limited to, anger, disgust, happiness, sadness, fear, and surprise. This reuse of the model architecture allows for integration of emotion detection into the existing system, enabling dynamic adjustments to the learning experience based on both the user's engagement level and emotional state. When an error is detected in the pronunciation error detection system, the system uses data from these background tasks to provide contextualized feedback. For example, if low engagement is detected prior to an error, the feedback may include motivational elements. The root cause analysis may provide targeted suggestions for improvement, making the feedback personalized.

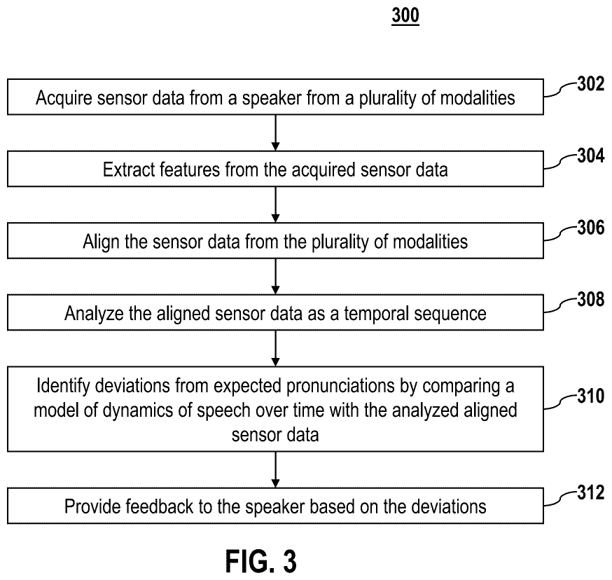

Referring now to FIG. 3, method 300 for assisted language learning includes, but is not limited to including, acquiring 302 sensor data from a speaker from a plurality of modalities, extracting 304 features from the acquired sensor data, aligning 306 the sensor data from the plurality of modalities, analyzing 308 the aligned sensor data as a temporal sequence, identifying 310 deviations from expected pronunciations by comparing a model of dynamics of speech over time with the analyzed aligned sensor data, and providing 312 feedback to the speaker based on the deviations.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein.

While the present teachings have been illustrated with respect to one or more implementations, alterations and/or modifications can be made to the illustrated examples without departing from the spirit and scope of the appended claims. In addition, while a particular feature of the present teachings may have been disclosed with respect to only one of several implementations, such feature may be combined with one or more other features of the other implementations as may be desired and advantageous for any given or particular function. As used herein, the terms “a”, “an”, and “the” may refer to one or more elements or parts of elements. As used herein, the terms “first” and “second” may refer to two different elements or parts of elements. As used herein, the term “at least one of A and B” with respect to a listing of items such as, for example, A and B, means A alone, B alone, or A and B. Those skilled in the art will recognize that these and other variations are possible. Furthermore, to the extent that the terms “including,” “includes,” “having,” “has,” “with,” or variants thereof are used in either the detailed description and the claims, such terms are intended to be inclusive in a manner similar to the term “comprising.” Further, in the discussion and claims herein, the term “about” indicates that the value listed may be somewhat altered, as long as the alteration does not result in nonconformance of the process or structure to the intended purpose described herein. Finally, “exemplary” indicates the description is used as an example, rather than implying that it is an ideal.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompasses by the following claims.

1. A method for assisted language learning comprising:
acquiring sensor data from a speaker from a plurality of modalities;
extracting features from the acquired sensor data;
aligning the sensor data from the plurality of modalities;
analyzing the aligned sensor data as a temporal sequence; and
identifying deviations from expected pronunciations by comparing a model of dynamics of speech over time with the analyzed aligned sensor data.

2. The method of claim 1, further comprising:
predicting phonemes by providing the analyzed aligned sensor data to a trained machine learning model;
determining pronunciation errors based on a comparison of the predicted phonemes with ground truth phonemes; and
providing feedback to the speaker based on the pronunciation errors.

3. The method of claim 1, wherein the feedback comprises:
highlighting areas where pronunciation differs from language norms.

4. The method of claim 1, further comprising:
classifying the deviations based on a type of error.

5. The method of claim 1, wherein the sensor data are acquired substantially contemporaneously.

6. The method of claim 1, further comprising:
transforming raw waveforms of the sensor data into a spectral representation that highlights or isolates the features.

7. The method of claim 6, wherein the features comprise:
one or more of facial movements or articulatory gestures related to speech sounds.

8. The method of claim 6, further comprising:
training a machine learning model to predict phonemes based at least on the features.

9. The method of claim 8, wherein the trained machine learning model comprises:
a sequence model architecture.

10. The method of claim 1, further comprising:
identifying speech presence.

11. The method of claim 1, further comprising:
determining a direction and an angle of the speaker during speech based on head orientation.

12. The method of claim 1, further comprising:
determining where the speaker is looking based on gaze estimation.

13. The method of claim 1, further comprising:
determining environmental influence on a speaker's articulation and attention based on environmental conditions.

14. The method of claim 1, further comprising:
performing a segment-by-segment dissection of a speaker's speech to determine aspects of components involved in pronunciation.

15. The method of claim 1, wherein the sensor data comprises:
image data and audio data from the speaker;
determining an identification of the speaker; and
determining one or more emotions of the speaker.

16. The method of claim 1, wherein the plurality of modalities comprises:
one or more of an audio sensor, a visual sensor, a LiDAR sensor, a radar, a mmWave/THz sensor, or an IR sensor.

17. The method of claim 1, wherein analyzing the aligned sensor data comprises:
combining the features using cross-model attention.

18. The method of claim 1, further comprising:
dividing the sensor data into segments;
annotating the segments with one or more labels; and
determining background or ambient noise based on the sensor data.

19. A computer system for assisted language learning comprising:
a hardware processor; and
a non-volatile storage medium storing instructions that when executed by the hardware processor perform operations comprising:
acquiring sensor data from a speaker from a plurality of modalities;
extracting features from the acquired sensor data;
aligning the sensor data from the plurality of modalities;
analyzing the aligned sensor data as a temporal sequence;
identifying deviations from expected pronunciations by comparing a model of dynamics of speech over time with the analyzed aligned sensor data; and
providing feedback to the speaker based on the deviations.

20. A computer program product for assisted language learning, the computer program product comprising a computer readable storage medium having program instructions embodied therewith, the program instructions executable by a computing device to cause the computing device to perform operations comprising:
acquiring sensor data from a speaker from a plurality of modalities;
extracting features from the acquired sensor data;
aligning the sensor data from the plurality of modalities;
analyzing the aligned sensor data as a temporal sequence;
identifying deviations from expected pronunciations by comparing a model of dynamics of speech over time with the analyzed aligned sensor data; and
providing feedback to the speaker based on the deviations.
